(19) United States
(12) Patent Application Publication
(10) Pub. No.: US 2004/0090056 A1
(43) Pub. Date: May 13, 2004

(54) Folding type center headrest for vehicle

(76) Inventor: Young-Bok Sung, Gunpo-Si (KR)

Correspondence Address: MORGAN, LEWIS & BOCKIUS, LLP., 3300 HILLVIEW AVENUE, PALO ALTO, CA, 94304, US

(21) Appl. No.: 10/315,777

(22) Filed: Dec. 10, 2002

(30) Foreign Application Priority Data
Nov. 13, 2002 (KR) 2002-70395

(51) Int. Cl. B60R 21/04; B60R 21/055

(52) U.S. Cl. 280/751

(57) ABSTRACT

The present invention relates to a folding headrest for a vehicle. More particularly, this invention relates to a folding type center headrest that is used in a vehicle of which the interior is divided into a passenger compartment and a cargo compartment. The headrest can be pivoted from a stored position that provides the driver with a clear view of the rear of the vehicle to a downward position for use as a headrest.

### FIELD OF THE INVENTION

Generally, the present invention relates to a headrest for a vehicle. More particularly, the present invention relates to a folding type center headrest used in a vehicle that is divided into a passenger space and a cargo space.

### BACKGROUND OF THE INVENTION

In general, various kinds of headrests have been used in seats of vehicles. Headrests typically enhance the convenience of a seat for a passenger and help prevent the passenger from being injured during an accident. However a drawback of headrests is that they can disrupt the drivers view out the rear of a vehicle when the driver looks through the rear-view mirror.

Several folding type headrests have been developed for vehicles. In one such type the headrest folds down and backward into the backside of the backrest of a seat. When the passenger sits on the seat, the headrest is sprung or rotated upward and into position.

A drawback of this type of headrest is that the backrest must be folded and manipulated every time the headrest is to be extracted from the backrest for positioning into the traditional headrest location. This is an inconvenience to the driver and occupants of the vehicle. Also, because it is timely and technical to position this type of headrest, the passenger often does not do so, thereby risking serious injury to the head and neck if an accident occurs.

Another problem associated with passenger/cargo type vehicles is that typically rows of seats are installed, however, the middle seat is left without a headrest so the driver can adequately see out the rear. This creates a dangerous situation for a passenger sitting in that seat because in the event of an accident that passenger will likely be severely injured in the head and neck region.

What is needed is a headrest that is easy to positioning when a passenger sits in a seat and that does not remain in the drivers rear view when a passenger is not occupying the seat.

### SUMMARY OF THE INVENTION

The present invention provides a folding type center headrest for a vehicle. This headrest is particularly suited for use in vehicles in which the interior is divided between a passenger compartment and a cargo compartment. The convenience of the passenger is enhanced since the headrest allows support of the head while the passenger is sitting at the center of a rear seat. The drivers rear view is also enhanced since driver's rear view can be easily secured by folding the folding type headrest when it is not in use.

According to an aspect of the present invention, there is provided a folding type center headrest for a vehicle. The present invention includes a receiving space formed by bending rearward an upper end of a partition panel that typically divides the interior of the vehicle between a passenger compartment and a cargo compartment. Also included are brackets positioned below the receiving space and fixed onto the partition panel. A headrest member is also included that includes a shock-absorbing member and a supporting rod that penetrates through one side of the shock-absorbing member, such that both ends of the supporting rod protrude from the shock-absorbing member at opposite lateral surfaces. Finally, link rods are provided wherein one end of the link rods are hinged to the brackets and the other end of the link rods are attached to the supporting rods of the headrest member.

### BRIEF DESCRIPTION OF THE DRAWINGS

The above and other objects, advantages and features of the present invention will become apparent from the following description read in conjunction with the accompanying drawings, in which:

FIG. 1 shows a front view of the interior of a middle portion of a vehicle with a folding type center headrest according to an embodiment of the present invention installed therein;

FIG. 2 shows a side view of the interior of a middle portion of a vehicle with the folding type center headrest according to an embodiment of the present invention installed therein;

FIG. 3 is a perspective view of the folding type center headrest according to an embodiment of the present invention;

FIG. 4 is a front view of the folding type center headrest according to an embodiment of the present invention; and

FIG. 5 is a side view of the folding type center headrest according to an embodiment of the present invention.

### DETAILED DESCRIPTION OF THE INVENTION

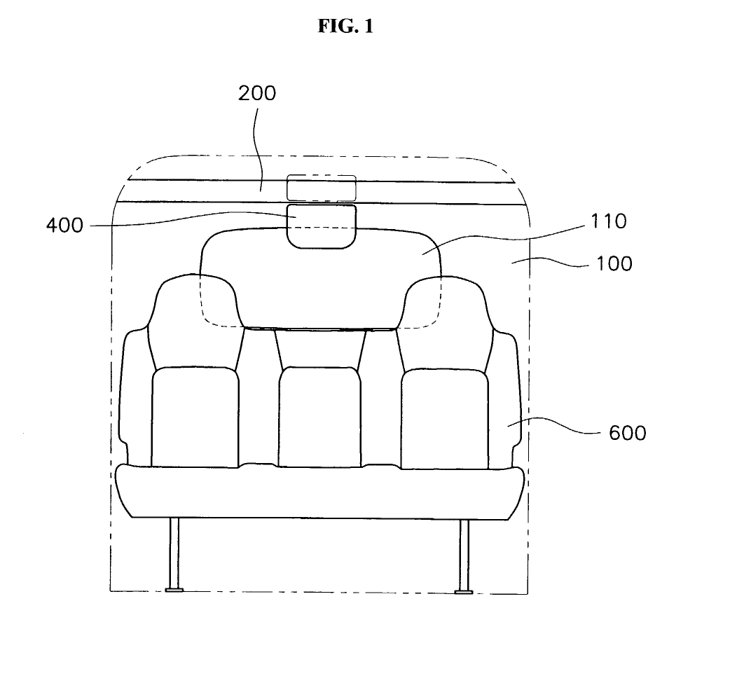

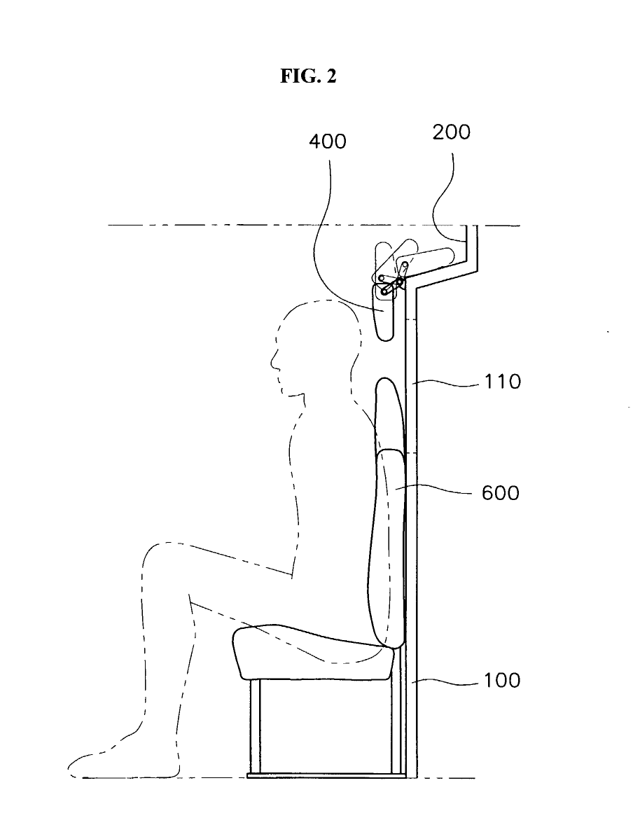

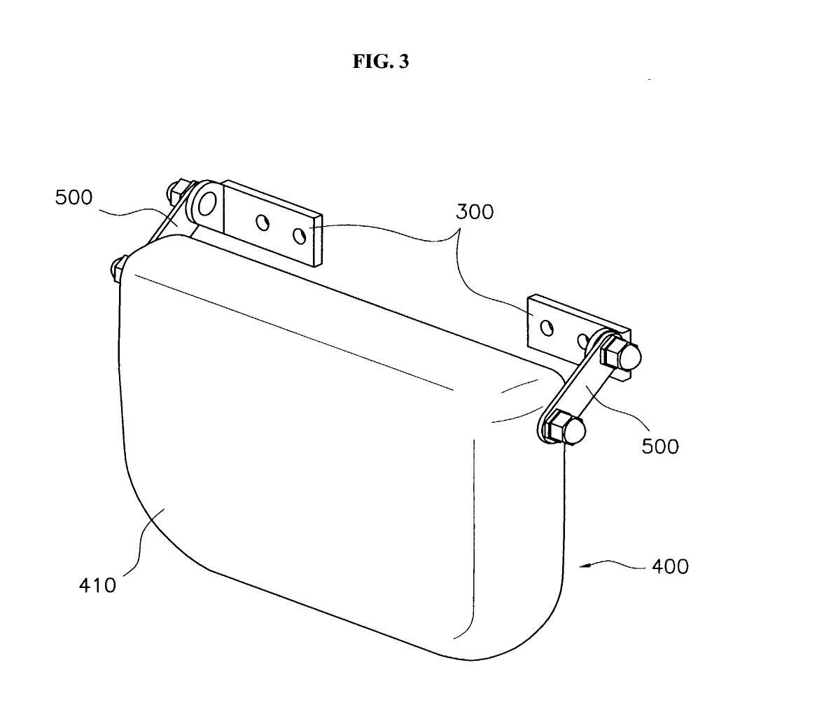

As shown in FIG. 1, a folding type center headrest of the present invention comprises a receiving space 200. The receiving space 200 is formed by bending rearward, an upper end of a partition panel 100 that is typically used for dividing the interior of the vehicle into either a passenger compartment or a cargo compartment. Brackets 300 (FIG. 3) are positioned below the receiving space 200 (FIG. 2) and fixed onto the partition panel 100.

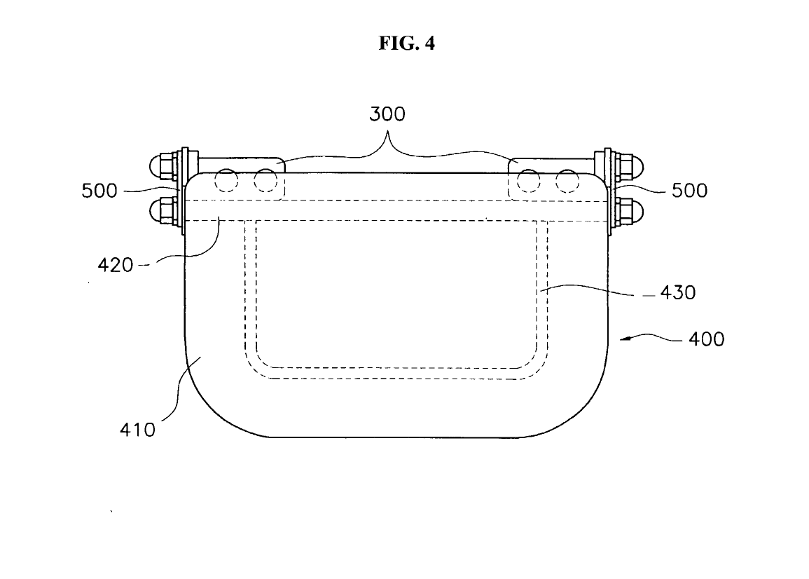

FIG. 4 shows the headrest member 400 according to an embodiment of the present invention. The headrest member 400 includes a shock-absorbing member 410 and a supporting rod 420. The supporting rod 420 extends laterally across the top portion of the headrest member 400 and protrudes therefrom on both sides. The supporting rod 420 is connected to linking rods 500 which in turn link to the brackets 300 for moveably mounting the headrest member 400. It is preferable that the headrest member 400 can be pivoted on the brackets 300, such that the headrest member 400 can be stored into the receiving space 200 when it is not in use.

FIG. 4 shows the supporting frame 430 embedded in the shock-absorbing member 410. In a preferred embodiment the supporting frame 430 is connected to the supporting rod 420 of the headrest member 400 for further support and strength.

Hereinafter, an operation of the present invention will be explained with reference to FIGS. 1 to 5.

According to FIGS. 1 and 2, the interior of the vehicle is separated into the passenger room and the cargo room by the partition panel 100. Further, a rear seat 600, for carrying passengers, is fixed to the vehicle floor. The rear seat 600 is provided in front of the partition panel 100 and a glass window 110 is provided toward the middle portion of the partition panel 100, such that a driver can easily view the rear of the vehicle.

In a preferred embodiment, a portion of the upper end of the partition panel 100 is bent to define the receiving space 200. The folding type center headrest of the present invention is provided above an upper central portion of the window glass 110 in the partition panel 100. Referring to FIG. 3, the headrest member 400 includes a shock absorbing member 410 made of a shock-absorbing material. In a preferred embodiment, according to FIG. 4, the supporting rod 420 penetrates through both lateral upper sides of the headrest member 400 such that the ends of the supporting rod 420 protrude from the headrest member. Therefore, the supporting rod 420 supports the shock-absorbing member 410.

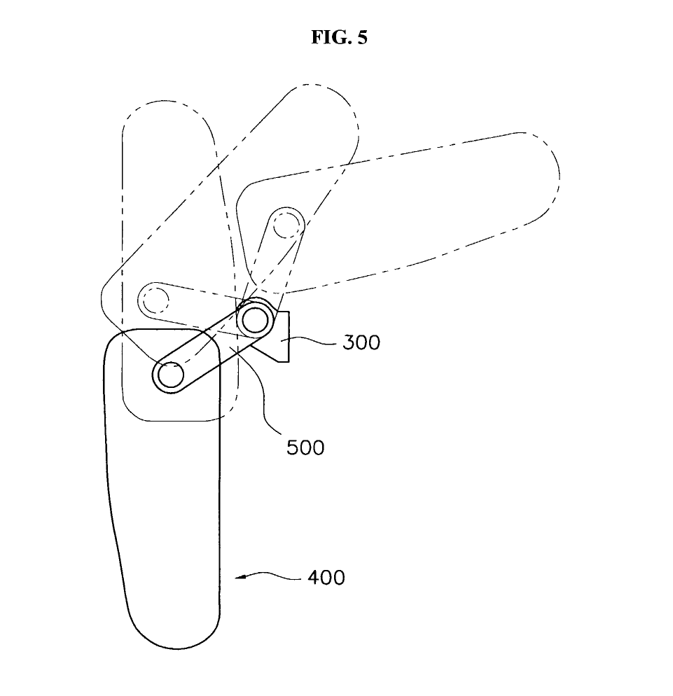

Link rods 500 (FIGS. 4 and 5) are hinged between the supporting rod 420 of the headrest member 400 and the brackets 300. Therefore, in use, the headrest member 400 is foldably connected to the partition panel 100 by the link rods 500 and the brackets 300. Furthermore, as shown in FIG. 4, the supporting frame 430, for supporting the shock-absorbing member 410, is also connected to the supporting rod 420 of the headrest member 410. The supporting frame 430 increases the strength of the headrest member 400, such that it supports a passenger's head during an accident.

The operation of the folding type center headrest of the present invention constructed as such will be hereinafter explained according to whether the center headrest is in use or not.

In use, if the passenger sits in the center position of the seat 600 and intends to use the headrest of the present invention, the headrest member 400 is pivoted on the brackets 300 in a downward direction. Thus, the headrest can be conveniently utilized and the head of the passenger can be protected from impact with the window glass 110 in the occurrence of an accident. However, if no passenger sits in the center position of seat 600 use of the headrest is not necessary. Therefore, the headrest member 400 can be pivoted upward such that the headrest member 400 is placed into the receiving space 200. Thus, providing the driver with a clear view out the rear of the vehicle.

It will be understood by those skilled in the art that various changes and modifications may be made to the present invention without departing from the spirit and scope of the present invention. The scope of the present invention should therefore be construed based on the accompanying claims.

What is claimed is:

1. A folding type center headrest for a vehicle, comprising:
a receiving space formed by bending rearward an upper end of a partition panel for dividing the interior of the vehicle into a passenger room and a cargo room;
brackets positioned below the receiving space and fixed onto the partition panel;
a headrest member including a shock-absorbing member and a supporting rod wherein both ends of the supporting rod protrude from the shock-absorbing member at opposite lateral surfaces thereof; and
link rods wherein one end of said link rods is coupled with said brackets and the other end of said link rods is coupled with the ends of said supporting rod.

2. The headrest as claimed in claim 1, wherein the headrest member is pivoted on the brackets and stored in the receiving space when it is not in use.

3. The headrest as claimed in claim 1, further comprising a supporting frame configured for supporting the shock-absorbing member wherein said supporting frame is coupled with said supporting rod.

4. A folding type center headrest for a vehicle, comprising:
a headrest cushion member;
a support member protruding from opposite lateral sides of said headrest cushion member;
link rods rotatably coupled on a first end with said support member; and
brackets configured for mounting said headrest wherein said link rods couple on a second end with said brackets.

5. The headrest of claim 4, wherein said headrest is configured to be rotatably stored into a receiving space formed in an upper region of a partition panel for dividing the interior of the vehicle into a passenger compartment and a cargo compartment.
